(19) United States
(12) Patent Application Publication
(10) Pub. No.: US 2003/0212167 A1
(43) Pub. Date: Nov. 13, 2003

(54) Oxygen-scavenging polymer compositions

(75) Inventors: Dexi Weng, Franklin, MA (US); John A. Buono, Riverside, RI (US)

Correspondence Address: PERKINS, SMITH & COHEN LLP, ONE BEACON STREET, 30TH FLOOR, BOSTON, MA, 02108, US

(73) Assignee: Teknor Apex Company, Pawtucket, RI

(21) Appl. No.: 10/140,639

(22) Filed: May 8, 2002

(51) Int. Cl. C08K 11/00

(52) U.S. Cl. 524/16; 524/543

(57) ABSTRACT

A polymer composition capable of depleting oxygen from adjacent spaces is disclosed. One or more botanical extracts, either naturally occurring or synthetic, that contain proanthocyanidin or its derivatives are added to a base polymer or polymer blend prior to processing to provide the polymer with oxygen-scavenging benefits without adverse effect to the characteristics of the base polymer or polymer blend.

### BACKGROUND OF THE INVENTION

This invention relates generally to polymer compositions having oxygen scavenging abilities, and, more particularly to polymer compositions comprising extracts containing proanthocyanidins or derivatives thereof as an additive.

Exposure to oxygen can be detrimental to the taste, odor, color, and nutritional value of many beverages and perishable food items, such as fruit juices, baby food, tomato-based products, mushrooms, beer, and wine. Protection against such spoilage is critical to increasing the shelf life of these items. Polymers in general do not provide the necessary oxygen barrier properties nor are they capable of providing for the removal of oxygen from air trapped in the container during the packaging process. In bottles containing beer or fruit juice, for example, trapped air may remain in the space above the liquid within the bottle and additional air may permeate into the bottle during storage through the gasket in the bottle closure. If the bottle is made of polyester or polyethylene terephthalate (PET), under certain conditions, oxygen can also permeate through the bottle and into the bottle cavity.

Additives have often been used to overcome deficiencies in the properties of a polymer or otherwise improve its performance for specific uses. To this end, oxygen scavengers, such as ascorbic acid, have been added to polymers and polymer compositions to increase their usefulness as containers and protective films for food or beverages. Oxygen scavengers, by definition are highly reactive with oxygen, and are thus able to remove oxygen from the surrounding environment. By properly placing such oxygen scavengers, oxygen can be removed from the air space within the container. Oxygen-scavenging abilities may also protect the polymer itself against oxidative degradation both by atmospheric oxygen and auto-oxidation. However, certain oxygen scavenging additives found in the prior art require the use of transitional metal salts such as copper sulfate and the like which can have adverse effects on the properties of the base polymer or polymer blend.

Grape seeds, pine bark, and other botanical extracts have long been used as dietary supplements and food enhancers due to their reported strong antioxidant properties and indication such properties may provide protection against various diseases and the aging process. Proanthocyanidins, a class of flavenoids within these extracts, have been found to be the active antioxidation agent. Due to their highly reactive structure, the proanthocyanidins are able to scavenge active oxygen species such as superoxide (O₂), hydrogen peroxide (H₂O₂), hydroxyl radical (OH), or singlet oxygen, from their surrounding environment with oxygen scavenging properties twenty times more powerful than ascorbic acid. The addition of such potent oxygen scavenging abilities to polymer compositions would greatly improve the oxygen scavenging properties of such polymers and their usefulness in containers or as protective films for food and beverages.

It is, therefore, an object of the present invention to provide a polymer composition having an additive that imparts oxygen scavenging capabilities to the polymer composition, but does not hinder the physical properties of the base polymer or polymer blend.

It is yet another object of the present invention to provide a method of improving the oxygen scavenging capabilities of a polymer composition in a cost-effective manner.

It is another object of the present invention to provide for a polymer composition that may be used in containers for food and beverages to remove oxygen from air trapped within the adjacent cavity of the container, or air that has permeated into the adjacent cavity of the container to reduce oxygen degradation of the contents therein.

### SUMMARY OF THE INVENTION

The present invention provides for a polymer composition capable of depleting oxygen from adjacent spaces. One or more botanical extracts, either naturally occurring or synthetic, that contain proanthocyanidin or its derivatives, generally polyphenolic compounds, are added to a base copolymer or copolymer blend prior to processing (curing or polymerization) to provide for a polymer composition or matix with oxygen-scavenging benefits without adverse effect to the characteristics of the base polymer or polymer blend structure. The amount of the botanical extract added can be tailored to produce the oxygen-scavenging ability required for the intended use of the polymer composition.

As these botanical extracts are highly reactive with active oxygen species in the surrounding environment, lesser amounts of additive are required to provide the necessary oxygen scavenging capabilities thereby providing for a more cost-effective means of producing polymer compositions having such oxygen scavenging capabilities. The polymer compositions disclosed herein (extendible to other polymer compositions usable for containers) may be used in bottle caps, bottle cap liners, container bodies and other structures in which oxygen scavenging is beneficial to prevent diffusion of oxygen into a container or to deplete oxygen trapped or already diffused into the container, and in other applications where it is advantageous to deplete oxygen in, or from spaces adjacent to, polymer structures or matrices.

### DETAILED DESCRIPTION OF THE INVENTION

Proanthocyanidins are phenolic polymers built from catechin or epi-catechin monomer units. Generally, the proanthocyanidins are from two to seven catechin units long. Longer oligomers and the monomeric catechin and epi-catechin units also have oxygen-scavenging capability. Proanthocyanidins are found naturally in a variety of botanicals, such as grape seeds, pine bark, blackjack oak, horse chestnut, witch hazel and hawthorn. Proanthocyanidins are further found in apples, berries, barley, bean hulls, chocolate, rhubarb, rose hips, and sorghum. For example, extracts from grape seed and pine bark, both demonstrating very high antioxidative properties, have been found to contain between about 92% to about 95% proanthocyanidins and between about 80% to about 85% proanthocyanidins, respectively. Synthetic analogs of the botanical extracts also exist and one skilled in the art will recognize that such synthetic analogs may also be utilized in the present invention. Methods of preparing extracts containing proanthocyanidins are known and have been described in U.S. Pat. No. 5,912,363 and U.S. Pat. No. 5,484,594, for example, and many commercial sources for these extracts exist. None of these sources or references appears to suggest the incorporation of proanthocyanidin in a synthetic polymer matrix.

By admixing an extract containing proanthocyanidin or a proanthocyanidin derivative to a base polymer or polymer blend, oxygen scavenging abilities are imparted to such base polymer or polymer blend. Such extracts may be obtained in powder form and homogeneously mixed with the base polymer or polymer blend using conventional processing techniques. The exact amount of the extract to be added to the base polymer or polymer blend can vary depending upon the oxygen removal properties of the polymer composition or article made thereof, ranging from about 0.1 weight percent to about 90 weight percent of the polymer composition. Factors to be considered are the use of the polymer composition and the length and degree of the protection required for such use. Active oxygen species in the space adjacent the polymer composition of the present invention or an article made thereof, react with the phenolic groups on the aromatic rings of the catechin units of the proanthocyanidin or proanthocyanidin derivatives to form quinoa structures and are thereby removed from the space.

Many different polymers or blends thereof may be used as a base in the present invention as the botanical extracts discussed herein are compatible with a wide range of polymers. Suitable polymers for use as a base or as part of a blended polymer base include polyethylene, polypropylene, polystyrene, polyvinyl chloride, or polyolefin. Particularly preferred base polymers are polyvinyl chloride and blends thereof and thermoplastic elastomers, such as styrenic or SEEPS block copolymers, thermoplastic polyolefins, thermoplastic vulcanizates, ethylene vinyl acetate (EVA) copolymers, thermoplastic polyamides such as Pebax®, and blends of these copolymers. The base polymer or polymer blend selected is dependent upon the use requirements of the resulting polymer composition.

The polymer composition may further contain inert filler, processing aids, pigments, stabilizers, fire retardants, antioxidants, foaming agents and other conventional additives in conventional amounts depending upon the use intended for the polymer composition.

The advantages of the present invention is further illustrated by means of the following illustrative embodiments, which are given for purpose of illustration only and are not meant to limit the invention to the particular components and amounts disclosed therein.

### EXAMPLES

In Example I and II below, polymer compositions of the present invention were prepared containing varying percentages of grape seed extract (GSE). One gram sample pellets or tapes of each polymer composition were prepared along with a one gram samples of each base polymer or blend as a control. The samples of the compositions were added to an aqueous solution of 20 mg KMnO₄ in 4 l H₂O to test for oxygen scavenging ability. If the sample scavenges oxygen, the purple color of the permanganate solution is changed to colorless or brown or yellow after addition of a polymer sample due to redox reaction.

I. Polyvinyl Chloride (PVC) Composition

For each formulation, approximately 300 grams of a dry blend of a PVC resin, epoxy, plasticizer, additives, copper sulfate and powdered grape seed extract was charged to the mixing chamber of a Banbury (Farrel Corporation, Model 64A499) mixer at 40 psi steam pressure. The speed dial was set at 4 (or approximate rotor speed of 120 rpm) for a duration of 4 minutes or until the temperature reached 290° F. The extrudate was sheeted on a two-roll mill, then the sheet was ground into small pieces and stored. A tape was prepared from the ground and stored extrudate in a lab scale single screw extruder (C. W. Brabender Instruments, Inc., L/D ration of 25:1) having a screw diameter of 0.75 inches at a temperature of 370° F. Resulting tapes were 1 inch wide and approximately 0.030 inches thick. The control sample blend contained all ingredients except grape seed extract (GSE) and copper sulfate (CS).

For the PVC control 1, the formulation is (in phr):

| | |
|---|---|
| BCP 66 bag only (PVC resin, | 100 |
| from Borden Chemical) | |
| Drapex 10.4 Epoxy | 4 |
| DOP | 71 |
| Calcium stearate | 0.20 |
| Crodamide ER | 3.75 |
| Celogen OT | 0.82 |
| Safoam RIC | 1.1 |
| Zinc based stabilizer | 0.40 |
| Total | 181.27 |

TABLE IA

| | Time for | Time for |
|---|---|---|
| | KMnO₄ solu- | solution |
| | tion initial | color change to |
| | color change | brown or |
| Formulation | (min.) | yellow (min.) |
| PVC control 1 (PVC1) | No change | No change |
| 99.79% PVC1 + 0.16% GSE + 0.05% CS | 5 | overnight |
| 99.27% PVC1 + 0.55% GSE + 0.18% CS | 3 | <20 |
| 97.81% PVC1 + 1.65% GSE + 0.54% CS | 1 | <10 |
| 95.62% PVC1 + 3.30% GSE + 1.08% CS | 0.5 | <5 |

As shown in Table IA, the control sample did not change the color of the permanganate solution. However, the color of the permanganate solution was changed for the remaining formulations. The speed of the color change was directly proportional to the amount of grape seed extract added.

As expected, addition of the copper sulfate to the blend had an adverse effect on the properties of the base polymer. Table 1B shows the resulting tensile strength and percent elongation for each formulation in comparison to the control sample.

TABLE IB

| Formulation | Tensile (psi) | Elongation (%) |
|---|---|---|
| PVC control 1 (PVC1) | 1680 | 310 |
| 99.79% PVC1 + 0.16% GSE + 0.05% CS | 1470 | 290 |
| 99.27% PVC1 + 0.55% GSE + 0.18% CS | 1060 | 250 |
| 97.81% PVC1 + 1.65% GSE + 0.54% CS | 940 | 230 |
| 95.62% PVC1 + 3.30% GSE + 1.08% CS | 820 | 220 |

II. Thermoplastic Elastomer (TPE) Composition

For each formulation, approximately 300 grams of a dry blend of a thermoplastic elastomer blend of Septon® 4055 (available commercially from Septon Company of America), an SEEPS block copolymer, powdered grape seed extract and other ingredients was charged to the mixing chamber of a Banbury (Farrel Corporation, Model 64A499) mixer at 120 psi steam pressure. The speed dial was set at 4 (or approximate rotor speed of 120 rpm) for a duration of 5 minutes. The extrudate was sheeted, ground into small pieces and stored. A tape was prepared from the ground and stored extrudate in a lab scale single screw extruder (C. W. Brabender Instruments, Inc., L/D ration of 25:1) having a screw diameter of 0.75 inches at a temperature of 400° F. Resulting tapes were 1 inch wide and approximately 0.030 inches thick. Control sample blend contained all ingredients except grape seed extract.

TPE Control 1 (TPE 1) formulation (in phr):

| | |
|---|---|
| Septon ® 4055 (SEEPS) | 100 |
| Paraffinic mineral oil | 100 |
| Polypropylene | 40 |
| Incroslip C | 2.5 |
| Crodamide ORV | 1.2 |
| Total | 243.70 |

TABLE II

| | | Time for solution |
|---|---|---|
| | Time for KMnO₄ | color change to |
| | solution initial color | brown or yellow |
| Formulation | change (min.) | (min.) |
| TPE Control 1 (TPE 1) | No change | No change |
| 99.72% TPE 1 + 0.28% GSE | 4 | >20 |
| 99.44% TPE 1 + 0.56% GSE | 2.5 | <20 |
| 98.99% TPE 1 + 1.01% GSE | 1 | 5 |
| 97.98% TPE 1 + 2.02% GSE | 0.5 | 1 |

As shown in Table II, the control sample did not change the color of the permanganate solution, but all remaining formulation samples changed the color of the permanganate solution. The speed of the color change was directly proportional to the amount of grape seed extract added.

III. Comparison of Sodium Ascorbate (SA) and Grape Seed Extract (GSE) as Additives to TPE Base Polymer

Combinations of ascorbic acid or salts such as sodium ascorbate (SA) and transition metal salts such as copper sulfate (CS) have been known in the prior art (such as U.S. Pat. No. 5,977,212, U.S. Pat. No. 5,284,871, and WO 94/09084). TPE polymer compositions of the present invention were compared with TPE having sodium ascorbate (SA) and copper sulfate (CS) or sodium ascorbate alone as additives. One gram samples of each formulation were subjected to the permanganate solution test utilized in Examples I and II to ascertain oxygen scavenging capabilities. Melt integrity was also measured and assigned a scale of 1 to 4, 4 being best. Color change of each formulation during mixing of the extrudate in a lab Brabender mixer (C. W. Brabender Instruments, Inc.,) with a #6 bowl for 5 minutes at 200° C. was also observed.

TABLE III

| | Time for | | Time for |
|---|---|---|---|
| | KMnO₄ | Melt | Extrudate |
| | solution | Strength | Color Change |
| | initial color | (Scale of 1 | During Mixing |
| Formulation | change (min.) | to 4) | (min.) |
| 99.67% TPE 1 + 0.33% | 1 | 4 | No change |
| GSE | | | |
| 95.7% TPE 1 + 3.2% SA + | 5 | 2 | 1 |
| 1.1% CS | | | |
| 96.80% TPE 1 + 3.2% SA | 6 | 1 | 1 |
| 99.67% TPE 1 + 0.33% SA | No change | 2 | 3 |
| 99.54% TPE 1 + 0.33% | No change | 2 | 2.5 |
| SA + 0.11% CS | | | |

As can be seen in Table III, the TPE composition of the present invention demonstrated oxygen-scavenging capabilities while remaining thermally stable during processing. The formulations containing 3.2% of sodium ascorbate also showed oxygen-scavenging capabilities, but were not thermally stable. The formulations containing concentrations of sodium ascorbate comparable to the concentration of grape seed extract did not demonstrate oxygen scavenging abilities and were not thermally stable. Color change of the sodium ascorbate formulations during processing indicates degradation of the sodium ascorbate.

IV. Effects on Base Polymer Properties—PVC Composition

Samples of the present invention utilizing a PVC base polymer were prepared and tested for dynamic heat stability (at 190° C. at 100 rpm in a lab Brabender mixer (C. W. Brabender Instruments, Inc.,) with a #5 mixing bowl), static heat stability (at 190° C., initial color), tensile strength and % elongation. A control sample of the base polymer (PVC 2) without grape seed extract was also prepared. PVC 2 was essentially the same as PVC 1, except different PVC resin (oxyvinyl 450 F, commercially available from Oxyvinyls LP, instead of BCP 66) was used.

TABLE IV

| | Dynamic | Static | | |
|---|---|---|---|---|
| | Heat | Heat | | |
| | Stability | Stability | Tensile | Elongation |
| Formulation | (min.) | (min.) | (psi) | (%) |
| PVC Control 2 (PVC 2) | 36 | 15 | 1300 | 293 |
| 99.84% PVC 2 + 0.16% GSE | 32 | 15 | 1320 | 298 |
| 99.73% PVC 2 + 0.27% GSE | 34 | 15 | 1365 | 291 |
| 99.45% PVC 2 + 0.55% GSE | 34 | 15 | 1320 | 290 |
| 99.18% PVC 2 + 0.82% GSE | 34 | 15 | 1356 | 289 |
| 98.37% PVC 2 + 1.63% GSE | 34 | 15 | 1221 | 284 |

As can be seen in Table IV above and in contrast to the formulations shown in Table IB containing copper sulfate, the addition of the botanical extract alone did not adversely effect the properties of the base PVC polymer.

V. Effects on Base Polymer Properties—TPE Composition

Samples of the present invention utilizing the TPE dry blend of Example II were prepared and tested for tensile strength and % elongation. A control sample (TPE 2) of the base polymer without grape seed extract was also prepared. TPE 2 was essentially the same as TPE 1, except a different lubricant was used.

TPE Control 2 (TPE 2) formulation (in phr):

| | |
|---|---|
| Septon ® 4055 (SEEPS) | 100 |
| Paraffinic mineral oil | 100 |
| Polypropylene | 40 |
| Incroslip C | 0.8 |
| Dow MB50-314 | 5.0 |
| Total | 245.80 |

TABLE V

| Formulation | Tensile (psi) | Elongation (%) |
|---|---|---|
| TPE Control 2 (TPE 2) | 2070 | 257 |
| 99.84% TPE 2 + 0.16% GSE | 2093 | 250 |
| 99.68% TPE 2 + 0.32% GSE | 2060 | 240 |
| 99.20% TPE 2 + 0.80% GSE | 2040 | 240 |
| 98.01% TPE 2 + 1.99% GSE | 1970 | 260 |

As can be seen in Table V above, addition of the botanical extract did not adversely effect the properties of the base TPE polymer.

It is to be understood that the above-described embodiments are simply illustrative of the principles of the invention. In particular, it is expected that useful oxygen scavenging qualities can be achieved by admixing proanthocyanidin with other co-polymers than the ones specified here. Thus, Kraton®, as well as thermoplastic co-polyesters such as Hytrel®, urethanes and other polymer systems, may be used as base materials as appropriate for a structural application such as a container. Indeed, it is expected that any polymers used for containers having some porosity relative to oxygen atoms in a structurally useful (generally polymerized) state may be endowed with beneficial oxygen scavenging qualities by admizing the co-polymers with proanthocyanidin and equivalents. Various other modifications, changes, details and uses may be made by those skilled in the art that will embody the principles of the invention and fall within the spirit and scope thereof.

What is claimed is:

1. A polymer composition comprising:
a thermoplastic elastomer, and
at least one botanical extract homogeneously mixed therein.

2. The polymer composition of claim 1 wherein said extract contains proanthocyanidin in an amount sufficient to remove oxygen from adjacent spaces when the copolymers of said composition are polymerized.

3. The polymer composition of claim 2 wherein proanthocyanidin is present in an amount ranging from about 80% to about 85% of the botanical extract.

4. The polymer composition of claim 2 wherein proanthocyanidin is present in an amount ranging from about 92% to about 95% of the botanical extract.

5. The polymer composition of claim 1 wherein the botanical extract is from a botanical selected from the group consisting of grape seed, pine bark, blackjack oak, horse chestnut, witch hazel, hawthorn, apples, barley, bean hulls, rhubarb, rose hips, berries, and sorghum.

6. The polymer composition of claim 1 wherein the botanical extract is present in an amount ranging from about 0.1 weight percent to about 90 weight percent of the polymer composition.

7. The polymer composition of claim 1 wherein the botanical extract is a synthetic analog of a naturally occurring botanical extract.

8. A polymer composition comprising:
a polyvinyl chloride, and
at least one botanical extract homogeneously mixed therein.

9. The polymer composition of claim 8 wherein said extract contains proanthocyanidin in an amount sufficient to remove oxygen from adjacent spaces when the co-polymers of said composition are polymerized.

10. The polymer composition of claim 9 wherein proanthocyanidin is present in an amount ranging from about 80% to about 85% of the botanical extract.

11. The polymer composition of claim 9 wherein proanthocyanidin is present in an amount ranging from about 92% to about 95% of the botanical extract.

12. The polymer composition of claim 8 wherein the botanical extract is from a botanical selected from the group consisting of grape seed, pine bark, blackjack oak, horse chestnut, witch hazel, hawthorn, apples, barley, bean hulls, rhubarb, rose hips, berries, and sorghum.

13. The polymer composition of claim 8 wherein the botanical extract is present in an amount ranging from about 0.1 weight percent to about 90 weight percent of the polymer composition.

14. The polymer composition of claim 8 wherein the botanical extract is a synthetic analog of a naturally occurring botanical extract.

15. A polymer composition comprising:
a polyolefin, and
at least one botanical extract homogeneously mixed therein.

16. The polymer composition of claim 15 wherein said extract contains proanthocyanidin in an amount sufficient to remove oxygen from adjacent spaces when the copolymers of said composition are polymerized.

17. The polymer composition of claim 16 wherein proanthocyanidin is present in an amount ranging from about 80% to about 85% of the botanical extract.

18. The polymer composition of claim 16 wherein proanthocyanidin is present in an amount ranging from about 92% to about 95% of the botanical extract.

19. The polymer composition of claim 15 wherein the botanical extract is from a botanical selected from the group consisting of grape seed, pine bark, blackjack oak, horse chestnut, witch hazel, hawthorn, apples, barley, bean hulls, rhubarb, rose hips, berries, and sorghum.

20. The polymer composition of claim 15 wherein the botanical extract is present in an amount ranging from about 0.1 weight percent to about 90 weight percent of the polymer composition.

21. The polymer composition of claim 15 wherein the botanical extract is a synthetic analog of a naturally occurring botanical extract.

22. A polymer composition comprising:
a polystyrene, and
at least one botanical extract homogeneously mixed therein.

23. The polymer composition of claim 22 wherein said extract contains proanthocyanidin in an amount sufficient to remove oxygen from adjacent spaces when the copolymers of said composition are polymerized.

24. The polymer composition of claim 23 wherein proanthocyanidin is present in an amount ranging from about 80% to about 85% of the botanical extract.

25. The polymer composition of claim 23 wherein proanthocyanidin is present in an amount ranging from about 92% to about 95% of the botanical extract.

26. The polymer composition of claim 22 wherein the botanical extract is from a botanical selected from the group consisting of grape seed, pine bark, blackjack oak, horse chestnut, witch hazel, hawthorn, apples, barley, bean hulls, rhubarb, rose hips, berries, and sorghum.

27. The polymer composition of claim 22 wherein the botanical extract is present in an amount ranging from about 0.1 weight percent to about 90 weight percent of the polymer composition.

28. The polymer composition of claim 22 wherein the botanical extract is a synthetic analog of a naturally occurring botanical extract.

29. A polymer composition comprising:
a polyethylene, and
at least one botanical extract homogeneously mixed therein.

30. The polymer composition of claim 29 wherein said extract contains proanthocyanidin in an amount sufficient to remove oxygen from adjacent spaces when the copolymers of said composition are polymerized.

31. The polymer composition of claim 30 wherein proanthocyanidin is present in an amount ranging from about 80% to about 85% of the botanical extract.

32. The polymer composition of claim 30 wherein proanthocyanidin is present in an amount ranging from about 92% to about 95% of the botanical extract.

33. The polymer composition of claim 29 wherein the botanical extract is from a botanical selected from the group consisting of grape seed, pine bark, blackjack oak, horse chestnut, witch hazel, hawthorn, apples, barley, bean hulls, rhubarb, rose hips, berries, and sorghum.

34. The polymer composition of claim 29 wherein the botanical extract is present in an amount ranging from about 0.1 weight percent to about 90 weight percent of the polymer composition.

35. The polymer composition of claim 29 wherein the botanical extract is a synthetic analog of a naturally occurring botanical extract.

36. A polymer composition comprising:
one or more synthetic copolymers, and
a polyphenolic compound homogeneously mixed therein, wherein said polyphenolic compound comprises one or more catechin monomers.

37. A polymer composition of claim 36 wherein the polyphenolic compound is a proanthocyanidin or a derivative thereof.
